(19) United States
(12) Patent Application Publication
(10) Pub. No.: US 2017/0025661 A1
(43) Pub. Date: Jan. 26, 2017

(54) SENSOR LEAD SECURING ASSEMBLY AND METHOD

(71) Applicant: FORD GLOBAL TECHNOLOGIES, LLC, Dearborn, MI (US)

(72) Inventors: John Paul Gibeau, Canton, MI (US); Francisco Fernandez, Canton, MI (US); Tom M. Gunther, Canton, MI (US); Rajaram Subramanian, Ann Arbor, MI (US)

(21) Appl. No.: 14/806,823

(22) Filed: Jul. 23, 2015

(51) Int. Cl. H01M 2/20; B60L 11/18; B60R 16/04; H01M 10/48; H01R 4/24; H01R 12/62; H01R 43/26; B60L 3/00; H01R 25/14

(52) U.S. Cl. CPC H01M 2/206; B60L 3/00; B60L 11/1877; B60R 16/04; H01R 25/142; H01R 4/24; H01R 12/62; H01R 43/26; H01M 10/482; H01M 2220/20

(57) ABSTRACT

An exemplary electrified vehicle assembly includes a sensor lead, and a busbar having a protrusion that secures the sensor lead to electrically connect the sensor lead with the busbar. A method of holding a sensor lead includes securing a busbar to at least one terminal of a battery cell, and securing a sensor lead to the busbar using a protrusion of the busbar.

### TECHNICAL FIELD

This disclosure relates generally to securing a sensor lead in a battery pack of an electrified vehicle. More particularly, the disclosure relates to a busbar that includes a protrusion used to secure the sensor lead.

### BACKGROUND

Generally, electrified vehicles differ from conventional motor vehicles because electrified vehicles are selectively driven using one or more battery-powered electric machines. Conventional motor vehicles, in contrast to electrified vehicles, are driven exclusively using an internal combustion engine. The electric machines can drive the electrified vehicles instead of, or in addition to, an internal combustion engine. Example electrified vehicles include hybrid electric vehicles (HEVs), plug-in hybrid electric vehicles (PHEVs), fuel cell vehicles (FCVs), and battery electric vehicles (BEVs).

Traction batteries are used to power the electric machines. The traction batteries include groups of battery cells. Sensor leads can connect to the cells and other portions of the traction batteries. The sensor leads are used to, for example, monitor voltages at the battery cells.

### SUMMARY

An electrified vehicle assembly according to an exemplary aspect of the present disclosure includes, among other things, a sensor lead, and a busbar having a protrusion that secures the sensor lead to electrically connect the sensor lead with the busbar.

In a further non-limiting embodiment of the foregoing assembly, the assembly includes at least one arm of the protrusion. The at least one arm is folded over the sensor lead to hold the sensor lead.

In a further non-limiting embodiment of any of the foregoing assemblies, the protrusion is a continuous and monolithic portion of the busbar.

In a further non-limiting embodiment of any of the foregoing assemblies, the sensor lead is a voltage sensor lead.

In a further non-limiting embodiment of any of the foregoing assemblies, the assembly includes a ribbon cable including the sensor lead.

In a further non-limiting embodiment of any of the foregoing assemblies, the protrusion pierces the ribbon cable.

In a further non-limiting embodiment of any of the foregoing assemblies, the protrusion includes a first arm that pierces the ribbon cable on a first side of the sensor lead, and a second arm that pierces the ribbon cable on an opposing, second side of the sensor lead.

In a further non-limiting embodiment of any of the foregoing assemblies, the busbar is a first busbar, and the sensor lead is a first sensor lead of the ribbon cable. The ribbon cable includes a second sensor lead, and a second busbar has a protrusion that secures the second sensor lead.

In a further non-limiting embodiment of any of the foregoing assemblies, the protrusion of the busbar electrically connects the sensor lead to at least one terminal of a battery cell.

In a further non-limiting embodiment of any of the foregoing assemblies, the busbar is attached to the at least one terminal of a battery cell.

An electrified vehicle system according to an exemplary aspect of the present disclosure includes, among other things, a ribbon cable having at least a first sensor lead and a second sensor lead, a first battery cell, a second battery cell, a busbar attached a terminal of the first battery cell and a terminal of the second battery cell, and a protrusion of the busbar that holds the first sensor lead in electrical contact with the busbar.

In a further non-limiting embodiment of the foregoing system, a first arm of the protrusion extends through the ribbon cable such that a first portion of the first arm is on a first side of the ribbon cable and a second portion of the first arm is on an opposing, second side of the ribbon cable.

In a further non-limiting embodiment of any of the foregoing systems, a point of the protrusion pierces the ribbon cable to contact the first sensor lead.

In a further non-limiting embodiment of any of the foregoing systems, a second arm of the protrusion extends through the ribbon cable such that a first portion of the second arm is on a first side of the ribbon cable and a second portion of the second arm is on an opposing, second side of the ribbon cable. The first arm extends through the ribbon cable at a first position between the first sensor lead and the second sensor lead, and the second arm extends through the ribbon cable at a second position. The first position and the second position are on opposing lateral sides of the sensor lead.

A method of holding a sensor lead according to an exemplary aspect of the present disclosure includes, among other things, securing a busbar to at least one terminal of a battery cell, and securing a sensor lead to the busbar using a protrusion of the busbar.

In a further non-limiting embodiment of the foregoing method, the sensor lead is held within a ribbon cable.

In a further non-limiting embodiment of any of the foregoing methods, the method includes piercing the ribbon cable with the protrusion to electrically connect the protrusion with the sensor lead.

In a further non-limiting embodiment of any of the foregoing methods, the method includes extending the protrusion through the ribbon cable.

In a further non-limiting embodiment of any of the foregoing methods, the method includes folding a portion of the protrusion to clamp the sensor lead.

In a further non-limiting embodiment of any of the foregoing methods, the portion is a first portion of the protrusion, and further includes extending a second portion of the protrusion through the ribbon cable, and then folding the second portion of the protrusion to clamp the sensor lead. The first portion and the second portion extend through the ribbon cable on opposing sides of the sensor lead.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a schematic view of an example powertrain of an electrified vehicle.

FIG. 2 illustrates a perspective view of an array from a battery pack of the powertrain of FIG. 1.

FIG. 3 illustrates an upper ribbon cable having sensor leads to connect with portions of the battery pack of FIG. 3.

FIG. 4 illustrates a lower ribbon cable having sensor leads to connect with portions of the battery pack of FIG. 2.

FIG. 5 illustrates a section view at Line 5-5 in FIG. 3.

FIG. 6 illustrates a section view at Line 6-6 in FIG. 4.

FIG. 7 illustrates a busbar of the battery pack of FIG. 2.

FIG. 8 illustrates a close-up view of a protrusion of the busbar of FIG. 7.

FIG. 9 illustrates a close-up view of area 9 in FIG. 2 prior to securing a sensor lead.

FIG. 10 illustrates a section view at Line 10-10 in FIG. 9.

FIG. 11 illustrates a close-up view of area 9 in FIG. 2 securing the sensor lead using the protrusion.

FIG. 12 illustrates a section view at Line 12-12 in FIG. 11.

FIG. 13 illustrates a section view of a protrusion according to another exemplary embodiment.

FIG. 14 illustrates a perspective view of the protrusion of FIG. 13.

### DETAILED DESCRIPTION

This disclosure relates generally to securing sensor leads in a battery pack of an electrified vehicle. More specifically, the disclosure relates to securing the sensor leads using a protrusion of a busbar. The sensor lead is one of a plurality of sensor leads within a ribbon cable, in some examples.

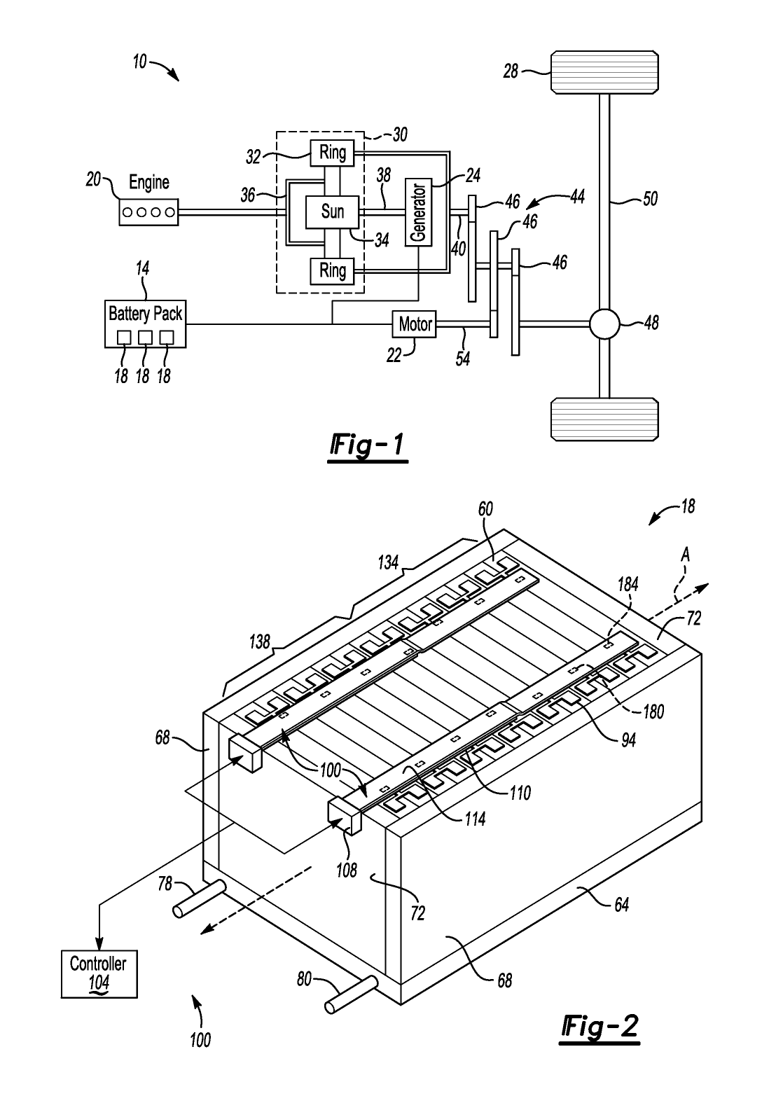

Referring to FIG. 1, a powertrain 10 of a hybrid electric vehicle (HEV) includes a battery pack 14 having a plurality of arrays 18, an internal combustion engine 20, a motor 22, and a generator 24. The motor 22 and the generator 24 are types of electric machines. The motor 22 and generator 24 may be separate or have the form of a combined motor-generator.

In this embodiment, the powertrain 10 is a power-split powertrain that employs a first drive system and a second drive system. The first and second drive systems generate torque to drive one or more sets of vehicle drive wheels 28. The first drive system includes a combination of the engine 20 and the generator 24. The second drive system includes at least the motor 22, the generator 24, and the battery pack 14. The motor 22 and the generator 24 are portions of an electric drive system of the powertrain 10.

The engine 20 and the generator 24 can be connected through a power transfer unit 30, such as a planetary gear set. Of course, other types of power transfer units, including other gear sets and transmissions, can be used to connect the engine 20 to the generator 24. In one non-limiting embodiment, the power transfer unit 30 is a planetary gear set that includes a ring gear 32, a sun gear 34, and a carrier assembly 36.

The generator 24 can be driven by the engine 20 through the power transfer unit 30 to convert kinetic energy to electrical energy. The generator 24 can alternatively function as a motor to convert electrical energy into kinetic energy, thereby outputting torque to a shaft 38 connected to the power transfer unit 30.

The ring gear 32 of the power transfer unit 30 is connected to a shaft 40, which is connected to the vehicle drive wheels 28 through a second power transfer unit 44. The second power transfer unit 44 may include a gear set having a plurality of gears 46. Other power transfer units could be used in other examples.

The gears 46 transfer torque from the engine 20 to a differential 48 to ultimately provide traction to the vehicle drive wheels 28. The differential 48 may include a plurality of gears that enable the transfer of torque to the vehicle drive wheels 28. In this example, the second power transfer unit 44 is mechanically coupled to an axle 50 through the differential 48 to distribute torque to the vehicle drive wheels 28.

The motor 22 can be selectively employed to drive the vehicle drive wheels 28 by outputting torque to a shaft 54 that is also connected to the second power transfer unit 44. In this embodiment, the motor 22 and the generator 24 cooperate as part of a regenerative braking system in which both the motor 22 and the generator 24 can be employed as motors to output torque. For example, the motor 22 and the generator 24 can each output electrical power to recharge cells of the battery pack 14.

Referring now to FIG. 2 with continuing reference to FIG. 1, the arrays 18 include a group of battery cells 60 disposed on a heat exchanger plate 64. The cells 60 are disposed along an axis A.

The example battery pack 14 includes three battery arrays. The battery pack 14 could include more than three battery arrays 18 or less than three battery arrays 18 in other examples.

The example battery array includes fourteen battery cells 60 but could include other number of cells 60. For example, a battery array of a full hybrid can include sixty battery cells, a battery array of a mild hybrid electrified vehicle can include twelve battery cells, and a battery array of a battery electric vehicle can include 90 battery cells. The cells 60 are lithium cells in this example, but could be of other chemistries.

The cells 60 are positioned laterally between a pair of sidewalls 68. The cells 60 are positioned, and clamped, axially between a pair of endwalls 72. The cells 60 are prismatic cells in this example. Other types of cells could be used in other examples including, but not limited to, cylindrical cells or pouch cells.

The example array 18 is cooled via liquid coolant communicated through the heat exchanger plate 64. Liquid coolant moves through an inlet conduit 78 to a coolant path established within the heat exchanger plate 64. The liquid coolant moves through the coolant path to exchange thermal energy with the cells 60 and other portions of the battery pack 14. The liquid coolant exits from the heat exchanger plate 64 at an outlet conduit 80. In this example, the coolant is used to cool the cells 60. In another example, the coolant is used to heat the cells 60.

A plurality of individual busbars 94 are positioned atop the cells 60. The busbars 94 attach to terminals of the cells 60. Electrical energy communicates to and from the cells 60 through the busbars 94 that are attached to the terminals. In this example, each individual busbar 94 connects to a terminal of one of the cells 60 and a terminal of an adjacent one of the cells 60.

A ribbon cable assembly 100 is operatively connected to a controller 104 and to the battery array 18. The example ribbon cable assembly 100 includes a connector 108, an upper ribbon cable 110 and a lower ribbon cable 114.

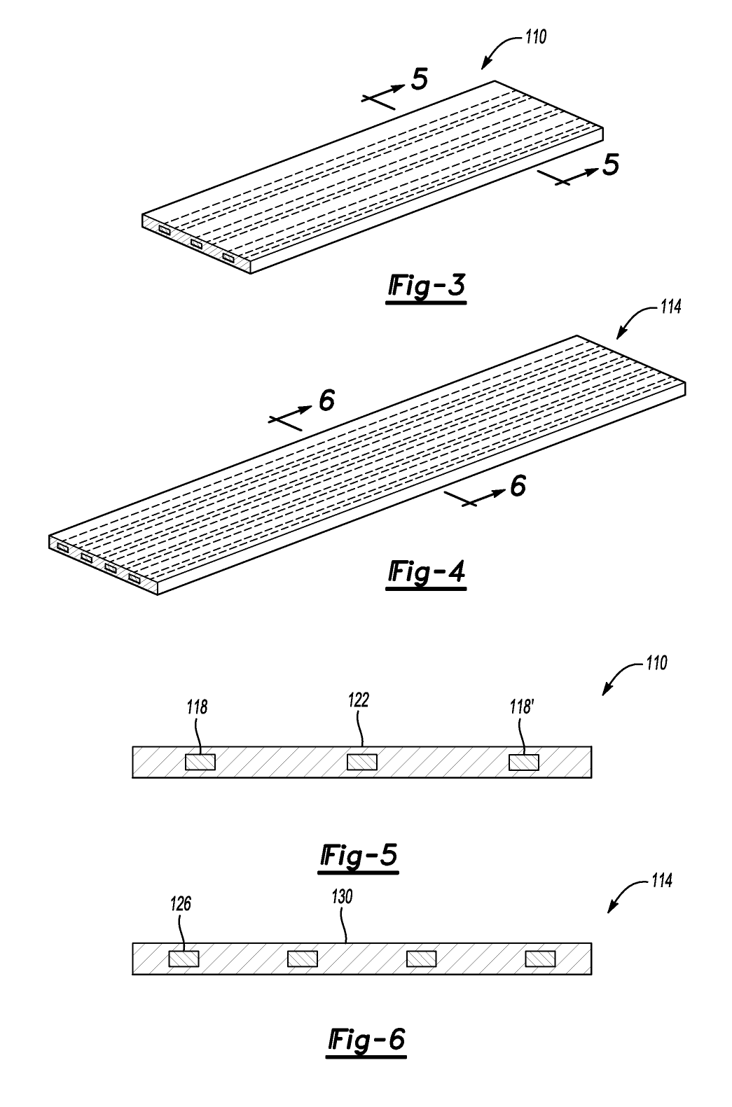

Referring now to FIGS. 3 to 6, with continuing reference to FIG. 2, the example upper ribbon cable 110 includes a plurality of sensor leads 118 embedded within a connective ribbon 122. The lower ribbon cable 114 includes a plurality of individual sensor leads 126 embedded within a connective ribbon 130. The sensor leads of the upper ribbon cable 110 are electrically coupled to selected cells 60 within a region 134 of the array 18. The sensor leads 126 of the lower ribbon cable are electrically connected to selected cells within a region 138 of the array 18. The sensor leads 118 and 126 extend from a respective one of the cells 60 to the connector 108, which is operatively coupled to the controller 104. The controller 104 collects information about the cells utilizing the sensor leads 118 and 126. For example, the controller 104 may collect voltage data utilizing information provided by the sensor leads 118 and 126. In some examples, relatively high potential sense lead wires connect the connectors 108 to the controller 104.

Within the battery array 18, the upper ribbon cable 110 is positioned atop the lower ribbon cable 114. Notably, the upper ribbon cable 110 extends into the region 134 whereas the lower ribbon cable 114 does not extend into the region 134. The upper ribbon cable 110 contacts cells in the region 134. The lower ribbon cable 114 contacts cells within the region 138.

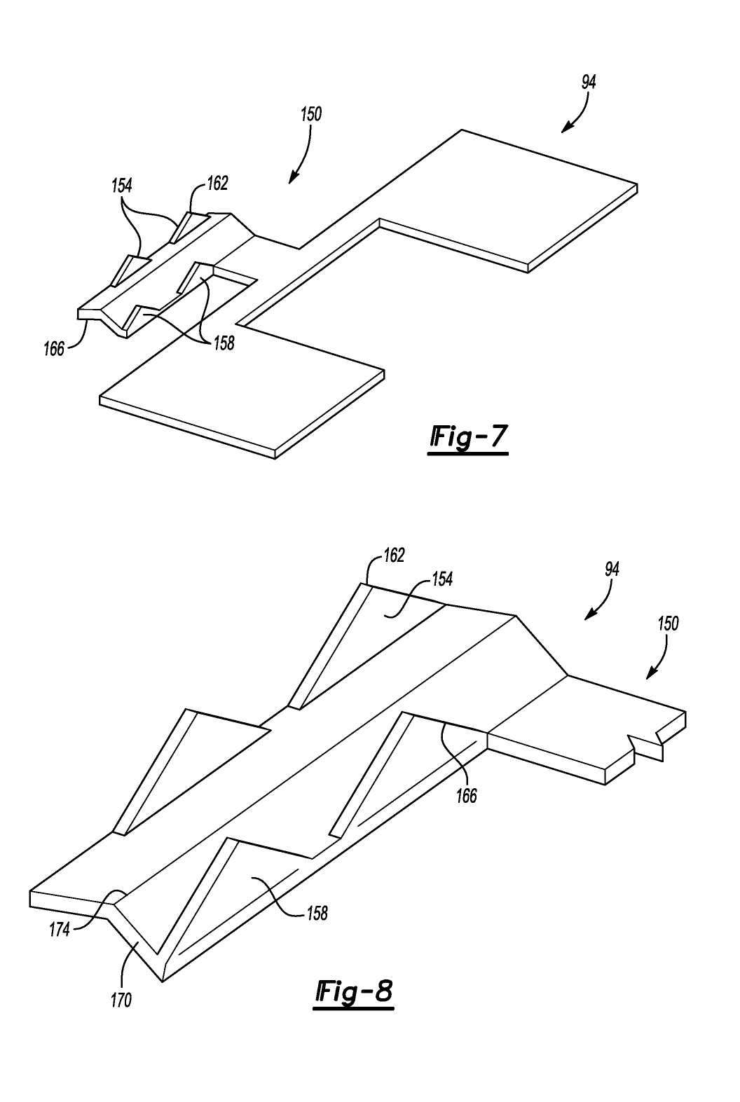

Referring now to FIGS. 7 to 12, with continuing reference to FIGS. 2 to 6, the sensor leads 118 and 126 are electrically connected to busbars 94 to enable the sensor leads 126 to gather data utilized by the controller 104. The example busbars 94 include a protrusion oieruib 150 that is used to secure one of the sensor leads 118 or 126 to a respective one of the busbars 94. When the sensor lead 118 or 126 is secured to one of the busbars 94, the sensor lead 118 or 126 is electrically connected to the busbar 94. Notably, the protrusion 150 is a continuous and monolithic portion of the busbar 94. The protrusion 150 can be provided by machining operations applied to the busbar 94. A person having skill in this art in the benefit of this disclosure would understand how to provide a protrusion from a sheet of material utilizing various manufacturing techniques.

The protrusion portion 150 includes a pair of first arms 154 and a pair of second arms 158. The arms 154 and 158 are triangular in side profile and terminate at a respective apex 162 or 166. The arms 154 and 158 extend from a base 170 of the protrusion 150. The base is bent such that the base 170 includes a point 174 extending in the same direction as the arms.

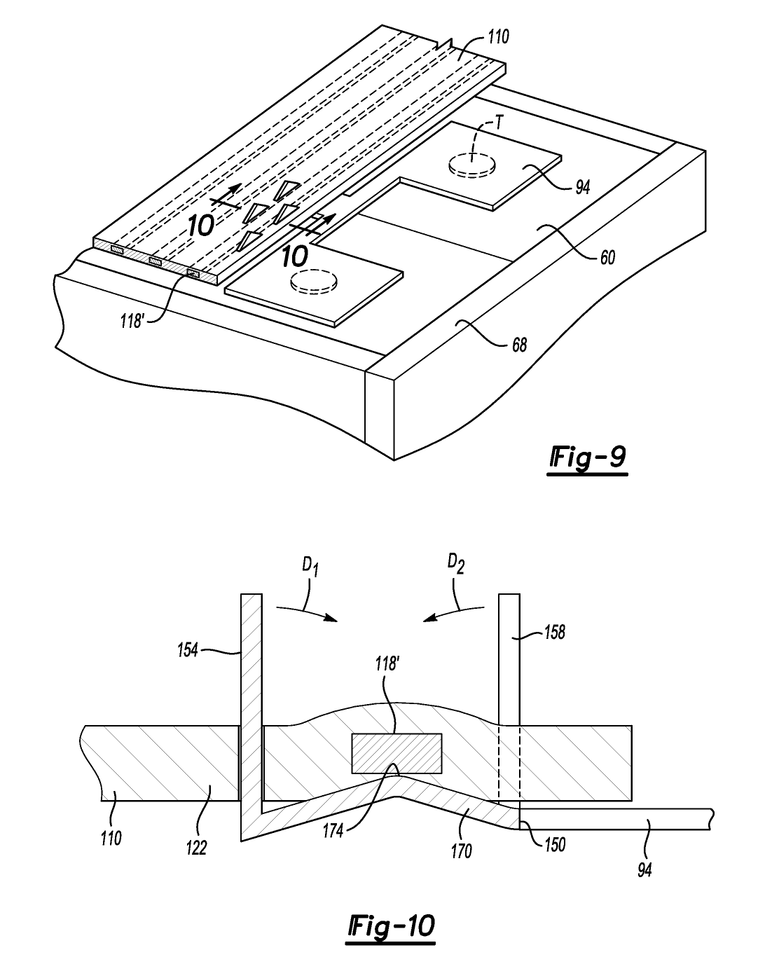

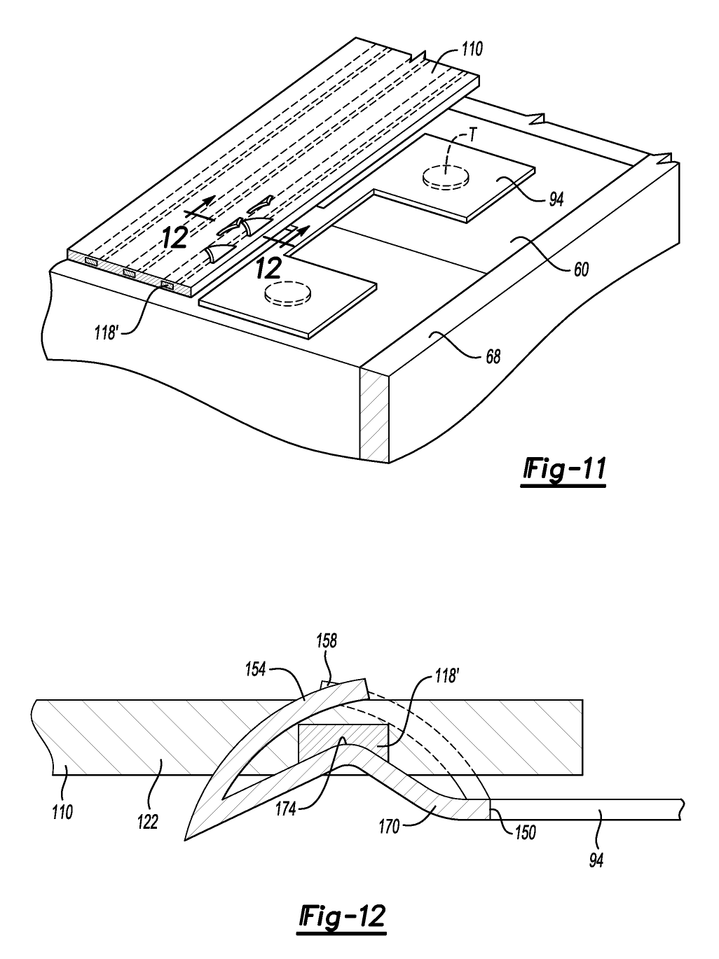

During assembly, the busbar 94 is welded to terminals T of adjacent cells 60 as shown in FIGS. 9 and 11. The upper ribbon cable 110 is then placed on the array 18. The upper ribbon cable 110 is pressed in the direction of the cells 60, which causes the apex 162 of the arm 154 and the apexes 166 of the arm 158 to pierce the connective ribbon 122 such that the arms 154 and 158 extend from a first downwardly facing side of the upper ribbon cable 110 to a second upwardly facing side of the upper ribbon cable 110.

The connective ribbon 122 of the upper ribbon cable 110 can be perforated near the sensor lead 118′ to facilitate moving the arms 154 and 158 through the connective ribbon 122. The upper ribbon cable 110 is positioned atop the array 18 such that one of the sensor leads 118′ is positioned laterally between the first arm 154 and the second arm 158.

After piercing the upper ribbon cable 110, the arms 154 and 158 are folded inwardly in the directions D₁ and D₂ to hold the upper ribbon cable 110 and, more specifically, to hold a portion of the sensor lead 118′ between the first arm 154 and the second arm 158.

Folding the arms 154 and 158 forces the upper ribbon cable 110, and specifically the sensor lead 118′ against the point 174 within the base 170 of the protrusion 150. After the arms 154 and 158 have been folded to the position of FIGS. 11 and 12, the point 174 has pierced a portion of the connective ribbon 122 and come into direct contact with the sensor lead 118′. When the point 174 is in direct contact with the sensor lead 118′, the busbar 94 is in electrical contact with the sensor lead 118′.

Referring again to FIG. 2, a similar technique is used to secure the remaining sensor leads in the upper ribbon cable 110 to busbars 94 at locations 180 and 184. Notably, the protrusion associated with the busbar at the location 180 extends closer to a median of the array 18 than the protrusion 150. This permits the busbar at the location 180 to align with the center sensor lead 118 in the upper ribbon cable 110. Similarly, the protrusion associated with the busbar at the location 184 extends closer to a median of the array 18 than the busbar at the location 180 and the busbar having the protrusion 150.

The upper ribbon cable 110 is secured to the cells of the array 18 in the region 134 after the lower ribbon cable 114 has been secured to respective busbars in the region 138. Busbars within the region 138 have protrusions mimicking the protrusions of the busbars in the region 134 to enable the busbars 94 and the region 138 to pierce areas of the lower ribbon cable 114 and to electrically connect to respective sensor leads 126 of the lower ribbon cable 114.

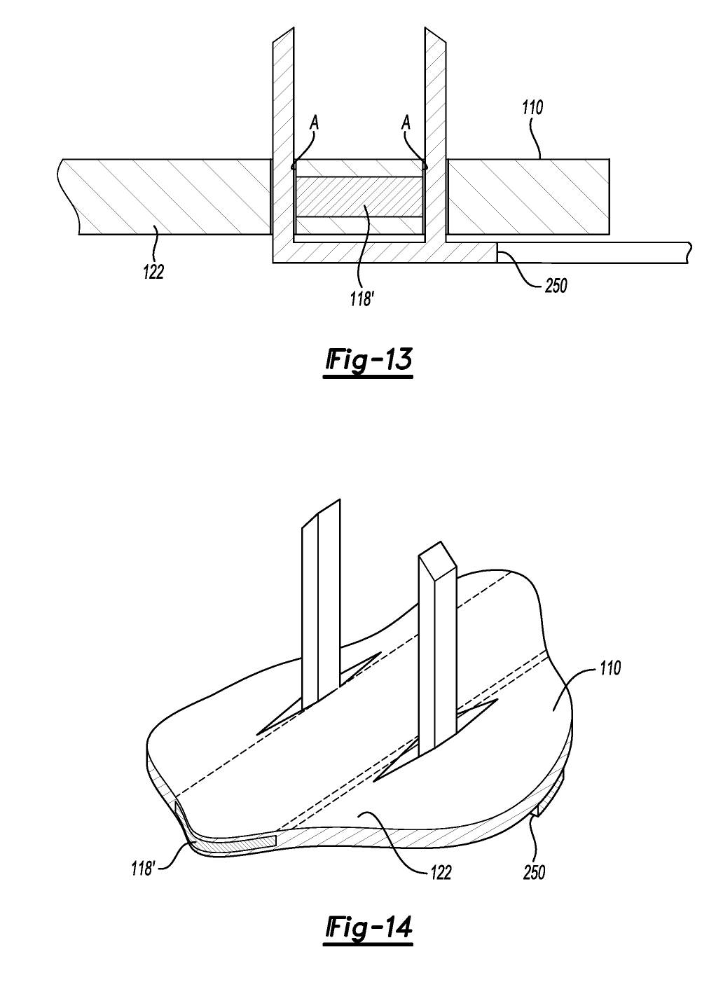

Referring now to FIGS. 13 and 14, another example protrusion 250 includes a first arm 254 and a second arm 258 extending from a base 270. After the arms 254 and 258 pierce the upper ribbon cable 110, the arms 254 and 258 directly contact the sensor lead 118′. Thus, in example of FIGS. 13 and 14, the protrusion 250 directly contacts the sensor lead 118′ without requiring a point in the base 270. The upper ribbon cable 110 can be perforated at areas P to cause the arms 254 and 258 to pierce the upper ribbon cable 110 near the sensor lead 118′.

After the piercing positions the arms 254 and 258 in the position of FIGS. 13 and 14, the arms 254 and 258 are then folded over the upper ribbon cable 110 to secure the sensor lead 118′ using the protrusion 250.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

What is claimed is:

1. An electrified vehicle assembly, comprising:
a sensor lead; and
a busbar having a protrusion that secures the sensor lead to electrically connect the sensor lead with the busbar.

2. The electrified vehicle assembly of claim 1, further comprising at least one arm of the protrusion, the at least one arm folded over the sensor lead to hold the sensor lead.

3. The electrified vehicle assembly of claim 1, wherein the protrusion is a continuous and monolithic portion of the busbar.

4. The electrified vehicle assembly of claim 1, wherein the sensor lead is a voltage sensor lead.

5. The electrified vehicle assembly of claim 1, further comprising a ribbon cable including the sensor lead.

6. The electrified vehicle assembly of claim 5, wherein the protrusion pierces the ribbon cable.

7. The electrified vehicle assembly of claim 5, wherein the protrusion comprises a first arm that pierces the ribbon cable on a first side of the sensor lead, and a second arm that pierces the ribbon cable on an opposing, second side of the sensor lead.

8. The electrified vehicle assembly of claim 5, wherein the busbar is a first busbar, and the sensor lead is a first sensor lead of the ribbon cable, wherein the ribbon cable includes a second sensor lead, and a second busbar has a protrusion that secures the second sensor lead.

9. The electrified vehicle assembly of claim 1, wherein the protrusion of the busbar electrically connects the sensor lead to at least one terminal of a battery cell.

10. The electrified vehicle assembly of claim 9, wherein the busbar is attached to the at least one terminal of a battery cell.

11. An electrified vehicle system, comprising:
a ribbon cable having at least a first sensor lead and a second sensor lead;
a first battery cell;
a second battery cell;
a busbar attached a terminal of the first battery cell and a terminal of the second battery cell; and
a protrusion of the busbar that holds the first sensor lead in electrical contact with the busbar.

12. The electrified vehicle system of claim 11, wherein a first arm of the protrusion extends through the ribbon cable such that a first portion of the first arm is on a first side of the ribbon cable and a second portion of the first arm is on an opposing, second side of the ribbon cable.

13. The electrified vehicle system of claim 12, wherein a point of the protrusion pierces the ribbon cable to contact the first sensor lead.

14. The electrified vehicle system of claim 12,
wherein a second arm of the protrusion extends through the ribbon cable such that a first portion of the second arm is on a first side of the ribbon cable and a second portion of the second arm is on an opposing, second side of the ribbon cable,
wherein the first arm extends through the ribbon cable at a first position between the first sensor lead and the second sensor lead, and the second arm extends through the ribbon cable at a second position, the first position and the second position on opposing lateral sides of the sensor lead.

15. A method of holding a sensor lead, comprising:
securing a busbar to at least one terminal of a battery cell; and
securing a sensor lead to the busbar using a protrusion of the busbar.

16. The method of claim 15, wherein the sensor lead is held within a ribbon cable.

17. The method of claim 16, further comprising piercing the ribbon cable with the protrusion to electrically connect the protrusion with the sensor lead.

18. The method of claim 17, further comprising extending the protrusion through the ribbon cable.

19. The method of claim 18, further comprising folding a portion of the protrusion to clamp the sensor lead.

20. The method of claim 18, wherein the portion is a first portion of the protrusion, and further comprising extending a second portion of the protrusion through the ribbon cable, and then folding the second portion of the protrusion to clamp the sensor lead, the first portion and the second portion extending through the ribbon cable on opposing sides of the sensor lead.
